(19) United States
(12) Patent Application Publication
(10) Pub. No.: US 2026/0003089 A1
(43) Pub. Date: Jan. 1, 2026

(54) METHODS AND SYSTEMS FOR LOCATING HYDROCARBONS USING TRAVELTIME-BASED REFLECTION FULL WAVEFORM INVERSION

(71) Applicant: SAUDI ARABIAN OIL COMPANY, Dhahran (SA)

(72) Inventors: Hong Liang, Katy, TX (US); Young Seo Kim, Dhahran (SA); Yong Ma, Katy, TX (US)

(73) Assignees: ARAMCO SERVICES COMPANY, Houston, TX (US); SAUDI ARABIAN OIL COMPANY, Dhahran (SA)

(21) Appl. No.: 18/756,534

(22) Filed: Jun. 27, 2024

(51) Int. Cl. G01V 1/28; E21B 44/00; G01V 1/30; G01V 1/34

(52) U.S. Cl. CPC G01V 1/282; E21B 44/00; G01V 1/301; G01V 1/305; G01V 1/345; E21B 2200/20

(57) ABSTRACT

Systems and methods are disclosed. The method may include receiving observed seismic data, and a first and a second seismic velocity model, each pertaining to a subterranean region of interest and, iteratively, determining synthetic reflection data based on the first and second seismic velocity model, determining traveltime shift data between the synthetic observed seismic data, and determining warped observed seismic data by applying the traveltime shift data to the observed seismic data. The method further includes determining conditioned traveltime shift data using local similarity based on shaping regularization from the synthetic reflection data, the warped observed seismic data, and the traveltime shift data, and determining a seismic velocity model based on the first seismic velocity model and the conditioned traveltime shift data. The method also includes determining a seismic image from observed seismic data and the seismic velocity model, and a location of a hydrocarbon reservoir using the seismic image.

### BACKGROUND

In the oil and gas industry, a seismic survey may be conducted over a subterranean region to characterize the subterranean region in the search for hydrocarbon reservoirs. However, observed seismic data recorded during a seismic survey is in a time domain, accordingly, the observed seismic data may need to be transformed to a depth domain to locate the hydrocarbon reservoirs, if any.

A seismic velocity model relates recorded time and depth. Accordingly, a seismic velocity model may be used to transform the observed seismic data from a time domain to a depth domain. A modeling method known as full waveform inversion (FWI) may be used to determine the seismic velocity model. However, FWI may suffer from cycle skipping, which may result in an inadequate seismic velocity model.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method may include receiving, by a seismic processing system, an observed seismic data pertaining to a subterranean region of interest from a seismic acquisition system, receiving a first seismic velocity model and receiving a second seismic velocity model each pertaining to the subterranean region of interest. The method may further include iteratively or recursively, until a stopping criterion is satisfied, determining synthetic seismic data based, at least in part, on the first seismic velocity model, determining an updated second seismic velocity model based, at least in part, on the second seismic velocity model, the observed seismic data, and the synthetic seismic data, determining synthetic reflection data based, at least in part, on the updated second seismic velocity model, determining, using dynamic image warping, traveltime shift data between the synthetic reflection data and the observed seismic data, determining warped observed seismic data by applying the traveltime shift data to the observed seismic data, determining, using local similarity based on shaping regularization, conditioned traveltime shift data based, at least in part, on the synthetic reflection data, the warped observed seismic data, and the traveltime shift data, and determining an updated first seismic velocity model based, at least in part, on the first seismic velocity model and the conditioned traveltime shift data. The method may further include determining a seismic velocity model of the subterranean region of interest based, at least in part, on the updated first seismic velocity model, and determining a seismic image based, at least in part, on the observed seismic data and the seismic velocity model. The method may still further include determining, using a seismic interpretation workstation, a location of a hydrocarbon reservoir within the subterranean region of interest using, at least in part, the seismic image.

In general, in one aspect, embodiments relate to a system including from a seismic acquisition system, a seismic processing system, and a seismic interpretation workstation. The seismic acquisition system is configured to transmit observed seismic data to the seismic processing system. The seismic processing system is configured to receive observed seismic data receive, a first seismic velocity model, and a second seismic velocity model each pertaining to pertaining to a subterranean region of interest. The seismic processing system is further configured to iteratively or recursively, until a stopping criterion is satisfied, determine synthetic seismic data based, at least in part, on the first seismic velocity model, determine an updated second seismic velocity model based, at least in part, on the second seismic velocity model, the observed seismic data, and the synthetic seismic data, determine synthetic reflection data based, at least in part, on the updated second seismic velocity model, determine, using dynamic image warping, traveltime shift data between the synthetic reflection data and the observed seismic data, determine warped observed seismic data by applying the traveltime shift data to the observed seismic data, determine, using local similarity based on shaping regularization, conditioned traveltime shift data based, at least in part, on the synthetic reflection data, the warped observed seismic data, and the traveltime shift data, and determine an updated first seismic velocity model based, at least in part, on the first seismic velocity model and the conditioned traveltime shift data. The seismic processing system is still further configured to determine a seismic velocity model of the subterranean region of interest based, at least in part, on the updated first seismic velocity model, and determine a seismic image based, at least in part, on the observed seismic data and the seismic velocity model. The seismic interpretation workstation is configured to determine a location of a hydrocarbon reservoir within the subterranean region of interest using, at least in part, the seismic image.

In general, in one aspect, embodiments relate to a non-transitory computer-readable memory having computer-executable instructions stored thereon that, when executed by a computer processor, perform steps including receiving, from a seismic acquisition system, observed seismic data, receiving a first seismic velocity model, and receiving a second seismic velocity model each pertaining to a subterranean region of interest. The steps further including iteratively or recursively, until a stopping criterion is satisfied, determining synthetic seismic data based, at least in part, on the first seismic velocity model, determining an updated second seismic velocity model based, at least in part, on the second seismic velocity model, the observed seismic data, and the synthetic seismic data, determining synthetic reflection data based, at least in part, on the updated second seismic velocity model, determining, using dynamic image warping, traveltime shift data between the synthetic reflection data and the observed seismic data, determining warped observed seismic data by applying the traveltime shift data to the observed seismic data, determining, using local similarity based on shaping regularization, conditioned traveltime shift data based, at least in part, on the synthetic reflection data, the warped observed seismic data, and the traveltime shift data, and determining an updated first seismic velocity model based, at least in part, on the first seismic velocity model and the conditioned traveltime shift data. The steps still further include to determining a seismic velocity model of the subterranean region of interest based, at least in part, on the updated first seismic velocity model, determining a seismic image based, at least in part, on the observed seismic data and the seismic velocity model, and determining a location of a hydrocarbon reservoir within the subterranean region of interest using, at least in part, the seismic image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIGS. 2A-2E each illustrate seismic waves in accordance with one or more embodiments.

FIGS. 2F-2J each illustrate an associated collection of seismic traces organized by gather.

FIG. 3 displays observed seismic data in accordance with one or more embodiments.

FIG. 4 illustrates full waveform inversion (FWI) in accordance with one or more embodiments.

FIG. 5 displays a first seismic velocity model in accordance with one or more embodiments.

FIG. 6 displays synthetic reflection data in accordance with one or more embodiments.

FIG. 7 displays traveltime shift data in accordance with one or more embodiments.

FIG. 8 displays warped observed seismic data in accordance with one or more embodiments.

FIG. 9 displays a local similarity attribute in accordance with one or more embodiments.

FIG. 10 displays conditioned traveltime shift data in accordance with one or more embodiments.

FIG. 11 displays an updated first seismic velocity model in accordance with one or more embodiments.

FIGS. 12A and 12B display seismic velocity models in accordance with one or more embodiments.

FIG. 13 displays a ground truth seismic velocity model in accordance with one or more embodiments.

FIG. 14 describes a method in accordance with one or more embodiments.

FIG. 15 illustrates a computer system in accordance with one or more embodiments.

FIG. 16 illustrates a drilling system in accordance with one or more embodiments.

FIG. 17 illustrates a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a seismic velocity model” includes reference to one or more of such models.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

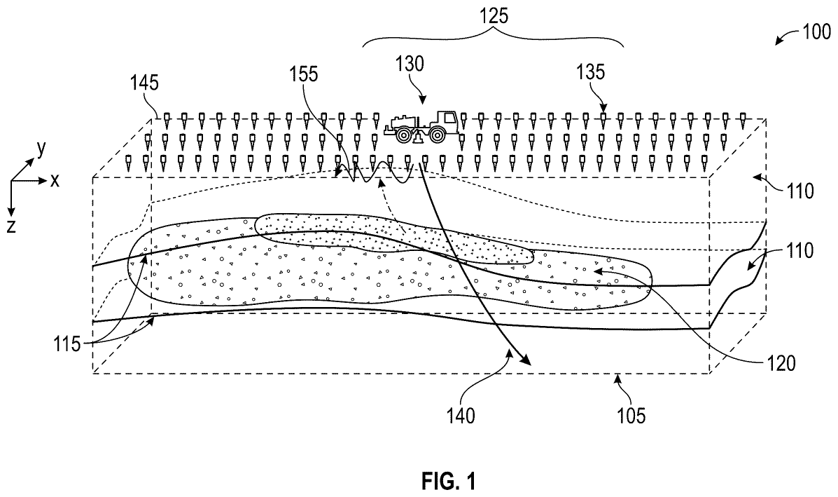

In the following description of FIGS. 1-17, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to locate a hydrocarbon reservoir within a subterranean region of interest. To do so, the methods may rely on multiple forms of full waveform inversion (FWI). FWI is an iterative modeling method used to determine a model based, in part, on observed seismic data collected during a seismic survey. In the context of this disclosure, the model is a seismic velocity model or portion thereof. The seismic velocity model m may be separated or decomposed into a first seismic velocity model m₀ and second seismic velocity model δm where:

$$m = {m}_{0} + δ m . \qquad Equation ( 1 )$$

In some embodiments, the seismic velocity model may be separated based on wavenumber (i.e., spatial frequency), which is inversely related to wavelength. For example, in some embodiments, the first seismic velocity model m₀ may be a low-wavenumber seismic velocity model (i.e., long-wavelength seismic velocity model). Further, in some embodiments, the second seismic velocity model δm may be a high-wavenumber seismic velocity model (i.e., short-wavelength seismic velocity model). Accordingly, each of the first seismic velocity model and second seismic velocity model is band limited.

It may be advantageous to decompose a seismic velocity model into a low-wavenumber seismic velocity model (i.e., a seismic velocity model that varies slowly spatially) and a high-wavenumber seismic velocity model (i.e., a seismic velocity model that varies rapidly spatially) as each have different properties. Low-wavenumber velocity variations affect the traveltime of seismic waves and may contribute to the focusing and defocusing of seismic waves. Further, low-wavenumber velocity variations do not generate reflected seismic waves of significant amplitude. In contrast, high-wavenumber velocity variations may not significantly affect the travel times of seismic waves and may not contribute to the focusing and defocusing of seismic waves. Further, high-wavenumber velocity variations do generate reflected seismic waves of significant amplitude (as do rapid variations in the mass density of a subterranean region).

Accordingly, selecting a reasonable wavenumber cutoff between the low-wavenumber seismic velocity model and high-wavenumber seismic velocity model may be subjective yet critical to ensure the low-wavenumber seismic velocity model and high-wavenumber seismic velocity model have the expected properties. To do so, the spectrum of the seismic traces of the observed seismic data should be considered when selecting the wavenumber cutoff to ensure the low-wavenumber seismic velocity model does not generate reflected seismic waves of significant amplitude and the high-wavenumber seismic velocity model does.

In some embodiments, FWI may separately determine a first seismic velocity model, a second seismic velocity model, and/or a seismic velocity model that includes the first seismic velocity model and second seismic velocity model. Hereinafter, the generic term “seismic velocity model” may describe a seismic velocity model that includes a first seismic velocity model and second seismic velocity model as given in Equation (1), only the first seismic velocity model, or only the second seismic velocity model unless otherwise stated.

To perform FWI, observed seismic data may be used. Observed seismic data may be collected during a seismic survey. FIG. 1 illustrates a seismic survey 100 in accordance with one or more embodiments. Specifically, FIG. 1 illustrates a surface seismic survey. The seismic survey 100 is conducted over a subterranean region of interest 105. The subterranean region of interest 105 may include layers of rock 110 separated by geological discontinuities 115. Further, in some embodiments, the subterranean region of interest 105 may include hydrocarbons stored within a hydrocarbon reservoir 120, the boundaries of which, particularly the upper boundary, may be a type of geological discontinuity 115.

A seismic acquisition system 125 is configured to conduct the seismic survey 100. The seismic acquisition system 125 includes at least one seismic source 130 and seismic receivers 135. The seismic source 130 is configured to generate radiated seismic waves 140 during the seismic survey 100. The type of seismic source 130 may depend on the environment in which the seismic source 130 is used. For example, on land, the seismic source 130 may be a vibroseis truck or explosive charge. In water, the seismic source 130 may be an airgun. The radiated seismic waves 140 may radiate along and into the subterranean region of interest 105. A portion of the radiated seismic waves 140 may return to the surface of the earth 145 as refracted seismic waves (hereinafter also “refractions”) (not shown), where wide-angle refractions may be referred to as diving waves. A portion of the radiated seismic waves 140 may be reflected by the geological discontinuities 115 and return to the surface of the earth 145 as reflected seismic waves 150 (hereinafter also “reflections”). A portion of the radiated seismic waves 140 may propagate along the surface of the earth 145 as Rayleigh waves or Love waves, collectively known as “ground roll” 155. Vibrations associated with ground roll 155 do not penetrate far beneath the surface of the earth 145 and, hence, are neither influenced by nor contain information about, deep portions of the subterranean region of interest 105. The collection of seismic waves propagating through the subterranean region of interest 105 may be referred to as a “wavefield.” Specifically, the seismic waves propagating downward into the subterranean region of interest 105 may be referred to as a “down-going wavefield.” The seismic waves propagating upward towards the surface of the earth 145 may be referred to as an “up-going wavefield.”

Each seismic receiver 135 is configured to detect and record the radiated seismic waves 140, reflected seismic waves 150, refracted seismic waves, and ground roll 155 collectively in time as a seismic trace during the seismic survey 100.

Accordingly, each seismic trace may include a waveform for one or more of one or more types of seismic waves. Each waveform may be associated with a traveltime. Traveltime is the time it takes for a seismic wave to propagate from the seismic source 130 to a seismic receiver 135. If the seismic wave is a single reflection 150, traveltime may be denoted “two-way traveltime” as the seismic wave initially propagated downward into the subterranean region of interest 105 one way, reflected at a geological discontinuity 115, and propagated upward towards the surface of the earth 145 a second way.

Denoting the position of the seismic source 130 as xₛ=(xₛ′, yₛ′, zₛ′) and the position of each seismic receiver 135 as xᵣ=(xᵣ′, yᵣ′, zᵣ′), respectively, the seismic trace recorded by each seismic receiver 135 may be denoted D(xₛ′, yₛ′, zₛ′, xᵣ′, yᵣ′, zᵣ′, t). Here, t is recording time or the time elapsed after the activation of the seismic source 130. The collection of all seismic traces acquired during the seismic survey 100 may be described as the observed seismic data. Accordingly, the observed seismic data may be initially collected in a time domain. To locate the hydrocarbon reservoir 120 within the subterranean region of interest 105, the observed seismic data may need to be transformed from the time domain to a depth domain.

While FIG. 1 specifically illustrates a surface seismic survey, a person of ordinary skill in the art will appreciate that other seismic surveys, such as vertical seismic profile (VSP) surveys, may be alternatively or additionally used to acquire the observed seismic data. Specifically, VPS surveys may use seismic receivers 135 disposed in a wellbore that penetrates the subterranean region of interest 105.

The collection of seismic traces among the observed seismic data may be organized into groups such that the seismic traces within each group share one or more common attributes. The seismic traces organized into each group may be generically referred to as a “gather.” Types of gathers include, without limitation, a common shot gather, common receiver gather, common offset gather, common midpoint gather, and common depth point gather. Hereinafter, the generic term “gather” may be used to denote any type of gather. As such, the collection of seismic traces among the observed seismic data may be organized into gathers.

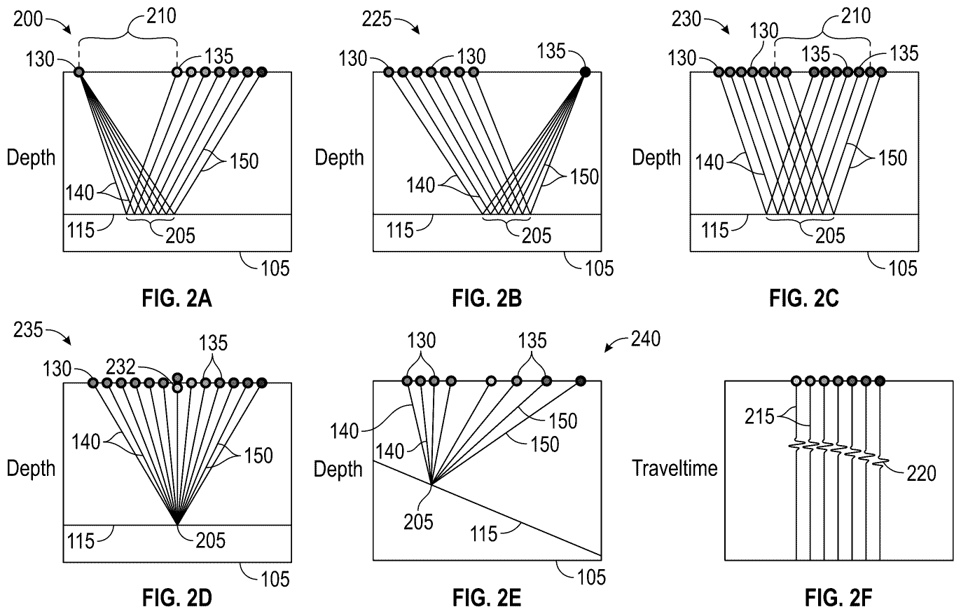

Each of FIGS. 2A-2E illustrates how a collection of seismic waves may propagate through a subterranean region of interest 105 when the associated collection of seismic traces is organized by gather. Each of FIGS. 2F-2J illustrates the associated collection of seismic traces organized by gather. While FIGS. 2A-2E only illustrate radiated seismic waves 140 and reflections 150 in two spatial dimensions for clarity, a person of ordinary skill in the art will appreciate that any type of gather may include radiated seismic waves 140, reflections 150, refractions, and ground roll 155 in three spatial dimensions without departing from the scope of the disclosure.

FIG. 2A illustrates a collection of seismic waves associated to a common shot gather 200. In a common shot gather 200 or simply “shot gather,” each radiated seismic wave 140 may appear to radiate from a common seismic source 130 (i.e., the common attribute), reflect at a geological discontinuity 115 within the subterranean region of interest 105 at one of several points 205 as a reflection 150, and be detected and recorded by uncommon seismic receivers 135. Each seismic receiver 135 may be equally offset relative to neighboring seismic receivers 135. Further, each seismic receiver 135 may be offset by an increasing source-receiver offset 210 relative to the seismic source 130. FIG. 2F illustrates an associated collection of seismic traces 215 that may be recorded in a time domain for a common shot gather 200. Each seismic trace 215 may be recorded by each seismic receiver 135 illustrated in FIG. 2A. Each seismic trace 215 may indicate the propagation time of a seismic wave that radiated from the seismic source 130, reflected at the geological discontinuity 115, and was detected and recorded by one seismic receiver 135. Each pulse 220 (i.e., source wavelet) within each seismic trace 215 may indicate when each seismic wave reflected at the geological discontinuity 115. Each pulse 220 or a collection of pulses 220 may be referred to as a “seismic event.” As such, a seismic event may be considered a manifestation of a geological discontinuity 115 within the subterranean region of interest 105. In a common shot gather 200, each pulse 220 within each seismic trace 215 may appear at increasing times with increasing source-receiver offsets 210 due to the increasing propagation distance. This phenomenon is known as “moveout.”

FIG. 2B illustrates a collection of seismic waves associated to a common receiver gather 225. In a common receiver gather 225, each radiated seismic wave 140 may appear to radiate from uncommon seismic sources 130, reflect at the geological discontinuity 115 within the subterranean region of interest 105 at one of several points 205 as a reflection 150, and be detected and recorded by a common seismic receiver 135 (i.e., the common attribute). Each seismic source 130 may be equally offset relative to neighboring seismic sources 130. FIG. 2G illustrates a corresponding collection of seismic traces 215 that may be recorded in a time domain for a common receiver gather 225. Again, each seismic trace 215 may indicate the propagation time of a seismic wave that radiated from each seismic source 130, reflected at the geological discontinuity 115, and was detected and recorded by the seismic receiver 135. The pulse 220 within each seismic trace 215 may indicate when the seismic waves reflected at the geological discontinuity 115. In a common receiver gather 225, each pulse 220 within each seismic trace 215 may appear at increasing times due to moveout.

FIG. 2C illustrates a collection of seismic waves associated to a common offset gather 230. In a common offset gather 230, each radiated seismic wave 140 may appear to radiate from uncommon seismic sources 130, reflect at the geological discontinuity 115 within the subterranean region of interest 105 at one of several points 205 as a reflection 150, and be detected and recorded at uncommon seismic receivers 135. Each seismic source 130 may be equally offset from neighboring seismic sources 130. Each seismic receiver 135 may also be equally offset relative to neighboring seismic receivers 135. However, the source-receiver offset 210 (i.e., the common attribute) between each location of a seismic source 130 and the corresponding location of a seismic receiver 135 is fixed for all seismic traces 215 within the common offset gather 230. FIG. 2H illustrates a corresponding collection of seismic traces 215 that may be recorded in a time domain for a common offset gather 230. Again, each seismic trace 215 may indicate the propagation time of a seismic wave that radiated from each seismic source 130, reflected at the geological discontinuity 115, and was detected and recorded by each seismic receiver 135. The pulse 220 within each seismic trace 215 may indicate when the seismic waves reflected at the geological discontinuity 115. In a common offset gather 230, each pulse 220 within each seismic trace 215 may appear at nearly the same time.

FIG. 2D illustrates a collection of seismic waves associated to a common midpoint gather 235. In a common midpoint gather 235, each radiated seismic wave 140 may appear to radiate from uncommon seismic sources 130, reflect at the geological discontinuity 115 within the subterranean region of interest 105 at one point 205 (i.e., the common depth point) as a reflection 150, and be detected and recorded by uncommon seismic receivers 135. Each seismic source 130 may be equally offset relative to neighboring seismic sources 130. Each seismic receiver 135 may also be equally offset relative to neighboring seismic receivers 135. However, the midpoint location (i.e., the common midpoint 232 and, accordingly, common attribute) between each location of a seismic source 130 and the corresponding location of a seismic receiver 135 is fixed within the common midpoint gather 235. FIG. 2I illustrates a corresponding collection of seismic traces 215 that may be recorded in a time domain for a common midpoint gather 235. As with a common shot gather 200 and common receiver gather 225, each pulse 220 within each seismic trace 215 may appear at increasing times due to moveout.

FIG. 2E illustrates a collection of seismic waves associated to a common depth point gather 240. In a common depth point gather 240, each radiated seismic wave 140 may appear to radiate from an uncommon seismic source 130, reflect at a geological discontinuity 115 with a dip within the subterranean region of interest 105 at one point 205 (i.e., the common depth point and, accordingly, the common attribute) as a reflection 150, and be detected and recorded by uncommon seismic receivers 135. Each seismic source 130 may or may not be equally offset relative to neighboring seismic sources 130. FIG. 2J illustrates a corresponding collection of seismic traces 215 that may be recorded in a time domain for a common depth point gather 240. As with a common offset gather 230, each pulse 220 within each seismic trace 215 may appear at nearly the same time.

Each of the collection of seismic traces 215 displayed in FIGS. 2F-2J may be referred to as “pre-stacked” gather or portion of the observed seismic data. Summing each of the collection of seismic traces 215 may be referred to as “post-stacked” gather or portion of the observed seismic data. Post-stacking may be performed to increase the signal-to-noise ratio of the observed seismic data.

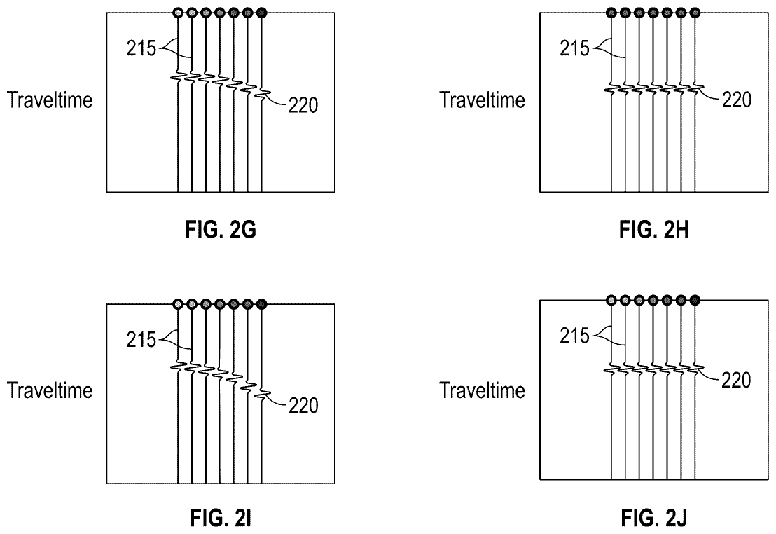

FIG. 3 displays observed seismic data 300 in accordance with one or more embodiments. Specifically, FIG. 3 displays a common shot gather 200 of the observed seismic data 300 collected during a seismic survey 100. Traveltime is shown along the ordinate 305. Receiver distance from a fixed origin point is shown along the abscissa 310. The grayscale quantifies the amplitude of a pulse 220 where black is a positive amplitude and white is a negative amplitude as shown by the scale bar. Accordingly, gray may be an amplitude near zero.

FWI may be performed to determine an updated seismic velocity model based, in part, on the observed seismic data 300. FWI is an iterative or recursive inversion method that may take various forms. Though FWI may be a nonlinear problem, FWI is often linearized. In one form, conventional FWI may use the entire waveforms of diving waves and other refractions within the observed seismic data 300 or portion thereof (e.g., a gather) to determine the updated seismic velocity model, such as an updated low-wavenumber seismic velocity model. In another form, reflection FWI (RFWI) may use the entire waveforms of reflections 150 within the observed seismic data 300 or portion thereof to determine the updated seismic velocity model. RFWI may be an improvement over conventional FWI as reflections 150 used within RFWI may penetrate deeper into the subterranean region of interest 105 than diving waves and other refractions and, thus, contain information deeper within the subterranean region of interest 105. However, conventional FWI and RFWI may not adequately determine the updated seismic velocity model due to amplitude differences between the observed seismic data 300 and synthetic seismic data. In still another form, traveltime-based RFWI may use the entire waveforms of reflections 150 within the observed seismic data 300 or portion thereof where a cost function relies on traveltime differences between the observed seismic data 300 and synthetic seismic data. Traveltime-based RFWI may be an improvement over conventional FWI and RFWI as the cost function used may mitigate amplitude differences and reduce the nonlinearity of the problem. Hereinafter, the acronym “FWI” generically denotes any type of FWI such as, without limitation, the three forms noted immediately above.

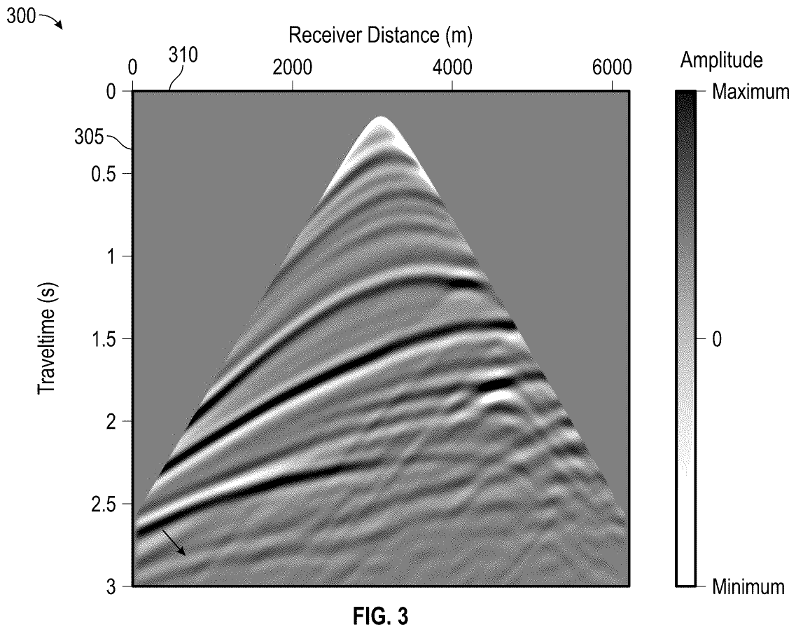

FIG. 4 illustrates FWI 400 in accordance with one or more embodiments. Though FWI 400 as illustrated in FIG. 4 is based on the observed seismic data 300, a person of ordinary skill in the art will appreciate that FWI 400 may be further based on additional constraints, such as those derived from well data. In some embodiments, the seismic velocity model 405 initialized and updated using FWI 400 may be a seismic velocity model m, first seismic velocity model m₀, or second seismic velocity model δm as given in Equation (1). However, the generic term “seismic velocity model” is used relative to FIG. 4 to generically describe FWI 400.

FWI 400 may start 410 by initializing a seismic velocity model 405. In some embodiments, the seismic velocity model 405 may be initialized using traveltime tomography. In other embodiments, the seismic velocity model 405 may be initialized as a laterally-homogeneous seismic velocity model where velocity changes with depth, typically increasing with increasing depth into the subterranean region of interest 105.

Following initialization of the seismic velocity model 405, forward modeling 415 may be applied to the seismic velocity model 405 to determine synthetic seismic data 420. Forward modeling 415 may be the process of solving or approximating physics-based equations that govern the relationship between the seismic velocity model 405 and synthetic seismic data 420. For example, forward modeling 415 may be the process of solving the elastic wave equation or an acoustic approximation to the wave equation to simulate how seismic waves propagate through the subterranean region of interest 105 as they would during a seismic survey 100—using the seismic velocity model 405 and a source wavelet to determine the synthetic seismic data 420.

A cost function 425 may compare the synthetic seismic data 420 and observed seismic data 300 or compare data derived from the synthetic seismic data 420 and observed seismic data 300 (e.g., conditioned traveltime shift data). A person of ordinary skill in the art will appreciate that the cost function 425 may be referred to as an objective function, error function, or misfit function without departing from the scope of the disclosure. Hereinafter, the term “cost function” will be used for consistency. A common cost function 425 may include a least-squares norm (i.e., a least-squares cost function). In these embodiments, the least-squares cost function may define a residual as the square of the difference between the synthetic seismic data 420 and observed seismic data 300. Though any cost function 425 that compares the synthetic seismic data 420 and observed seismic data 300 or derived data may be used without departing from the scope of the disclosure.

In some embodiments, the residual of the cost function 425 may be used to determine if a stopping criterion is satisfied as shown by decision block 430. For example, in some embodiments, if the residual is below a pre-defined threshold, the stopping criterion may be satisfied. In other embodiments, the stopping criterion may be a pre-defined number of iterations. In still other embodiments, if a difference between the residual and the previous residual is below a pre-defined threshold, the stopping criterion may be satisfied. If the stopping criterion is satisfied, the iterative process of FWI 400 ends 435. Accordingly, in some embodiments, the synthetic seismic data 420 may be considered adequately similar to the observed seismic data 300. Further, the seismic velocity model 405 may adequately represent the velocity of the seismic waves as they propagate through the subterranean region of interest 105.

If the stopping criterion is not satisfied, a gradient 440 may be used to determine the direction and rate at which the current seismic velocity model 405 should be perturbed. Use of a gradient 440 may be referred to as “gradient-based inversion.” Perturbation may be defined as adjusting or changing the current seismic velocity model 405 slightly using the gradient 440. Following perturbation, another iteration is performed using the perturbed or updated seismic velocity model 405. That is, forward modeling 415 is applied to the updated seismic velocity model 405 to determine updated synthetic seismic data 420, the observed seismic data 300 and the updated synthetic seismic data 420 are compared using the cost function 425, if the stopping criterion is not satisfied, the gradient 440 is updated, and the updated seismic velocity model 405 re-updated using the gradient 440.

As iterations increase, the cost function 425 and seismic velocity model 405 may converge to an extremum (e.g., a global minimum). Accordingly, as iterations increase, the synthetic seismic data 420 may look more similar to the observed seismic data 300. Once the convergence criterion is satisfied and FWI 400 ends 435, in some embodiments, the updated seismic velocity model 405 may be considered to adequately represent the subterranean region of interest 105.

However, FWI 400 may suffer from cycle skipping. Cycle skipping is the phenomenon where the cost function 425 and updated seismic velocity model 405 converge to a local extremum rather than the intended global extremum. Accordingly, the updated seismic velocity model 405 determined using FWI 400 may not be similar to the true seismic velocity model. Specifically, conventional FWI 400 that relies on a least-squares cost function 425 may suffer from cycle skipping when an initial low-wavenumber seismic velocity model is far from the true low-wavenumber seismic velocity model.

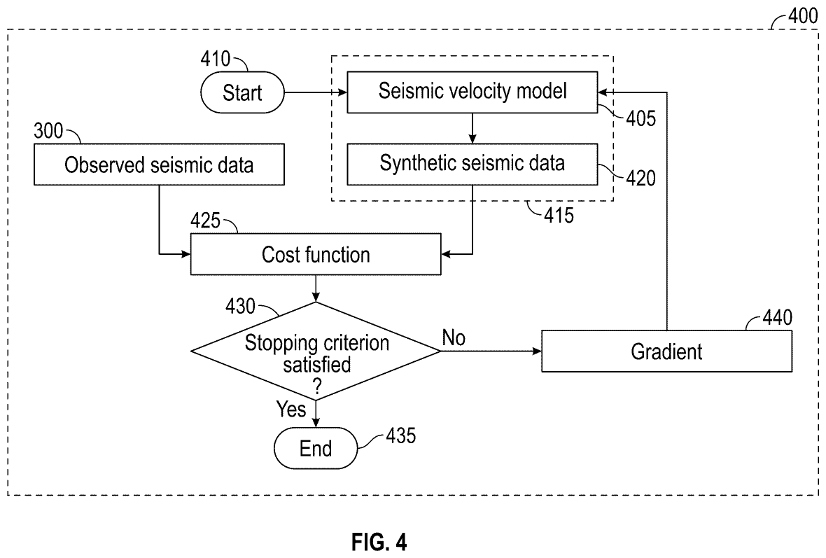

FIG. 5 displays an initial first seismic velocity model 405a in accordance with one or more embodiments. FIG. 5 specifically illustrates the initial first seismic velocity model 405a as a laterally-homogeneous seismic velocity model where velocity changes with depth, typically increasing with increasing depth into the subterranean region of interest 105. Depth is shown along the ordinate 500. Distance is shown along the abscissa 505. The grayscale quantifies the velocity as shown by the scale bar.

Forward modeling 415 may be applied to the initial first seismic velocity model 405a to determine synthetic seismic data 420 as described relative to FIG. 4. Because, in these embodiments, the first seismic velocity model 405a displayed in FIG. 5 is a smooth low-wavenumber seismic velocity model, no reflections 150 are generated within the synthetic seismic data 420.

The first seismic velocity model 405a may be used, in part, within conventional FWI 400 to update a previously-initialized second seismic velocity model. For conventional FWI 400 the initial second seismic velocity model is usually assigned to be zero everywhere within the subterranean region of interest. In some embodiments, the observed seismic data 300 and synthetic seismic data 420 determined from the first seismic velocity model 405a may be used to form a first cost function 425, where:

$${E}_{0} = \frac{1}{2} {\sum }_{{x}_{s} , {x}_{r}} {‖ d - {u}_{0} ‖}^{2} , \qquad Equation ( 2 )$$

where d is a scalar value among the observed seismic data d 300 and u₀ is a scalar value among the synthetic seismic data u₀ 420. Specifically, Equation (2) is a least-squares cost function. However, a person of ordinary skill in the art will appreciate that other cost functions 425 may be formed using the observed seismic data 300 and synthetic seismic data 420.

Following determination of the cost function 425, if the stopping criterion is not satisfied, a first gradient 440 is determined and used to perturb the current second seismic velocity model. In some embodiments, the first gradient 440 may rely on Green's function, which may be used to describe a wavefield. Recall that the seismic velocity model m that includes a first seismic velocity model m₀ and second seismic velocity model δm may be separated or decomposed as: shown in Equation (1). Accordingly, Green's function G may be separated or decomposed into two parts where:

$$G ( {m}_{0} + δ m ) = {G}_{0} ( {m}_{0} ) + δ G ( {m}_{0} , δ m ) , \qquad Equation ( 3 )$$

where G₀ describes a wavefield based on the first seismic velocity model m₀ and SG describes a scattered wavefield generated when the wavefield encounters the second seismic velocity model Sm. In some embodiments, the first gradient 440 used for perturbing the current second seismic velocity model may be:

$${g}_{δ m} = \int \int \int {dx}_{s} {dx}_{r} dt {\ddot{G}}_{0} ( x , t ; {x}_{s} ) ( {G}_{0} ( x , - t ; {x}_{r} ) * δ d ) , \qquad Equation ( 4 )$$

where x=(x, y, z) is the imaging location within the subterranean region of interest 105, xₛ and xᵣ is the location of the seismic source 130 and seismic receiver 135, respectively, \ddot{G}₀ is the second time derivative of G₀, and δd=d−u₀ is the residual between the observed seismic data d 300 and synthetic seismic data u₀ 420.

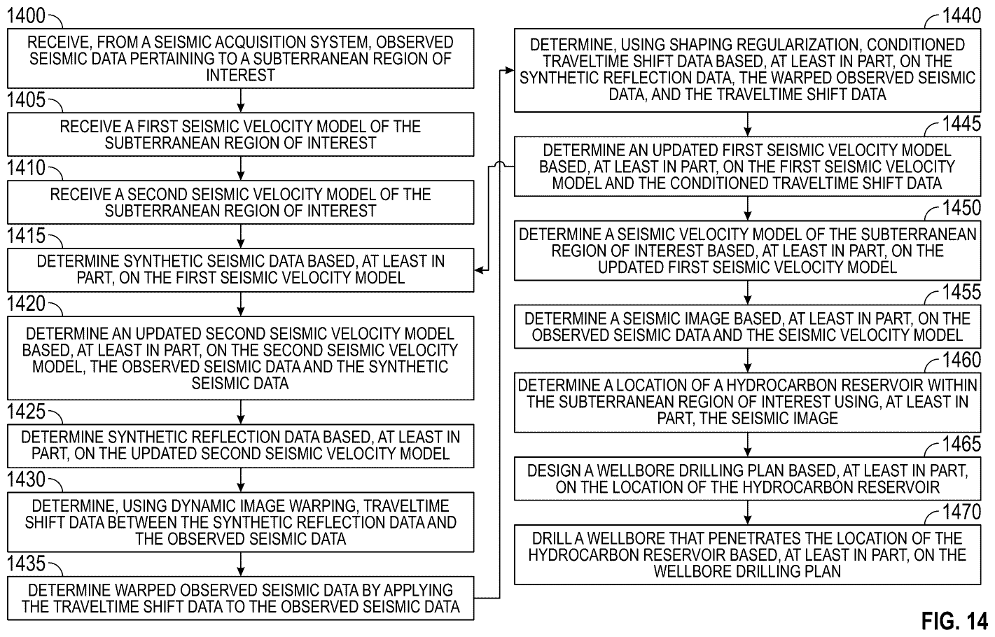

In accordance with one or more embodiments, the workflow may be viewed as including two steps within an iterative or recursive loop with each of the two steps applied in an alternating manner. The first step updates the second seismic velocity model, while the second step updates the first seismic velocity models. These steps may be repeated one after the other iteratively. The first stage may use conventional FWI with a gradient, such as the gradient in Equation (4), to update the second seismic velocity model (which may initially have a zero value everywhere). During this first step, the first (low-wavenumber) seismic velocity is held fixed and only the second or high-wavenumber seismic velocity model is updated (See step 1420 in FIG. 14). Then in the next step the second (high-wavenumber) seismic velocity model is held fixed and only the first (low-wavenumber) seismic velocity model is updated (See steps 1425, 1430, 1435, 1440, 1445 in FIG. 14).

In accordance with one or more embodiments, each iteration of this loop of the workflow may include an update to the second seismic velocity model followed by an update to the first seismic velocity model. Each loop of the iterative workflow may commence with a generation of updates synthetic seismic data based upon the updated first and second seismic velocity models determined in a previous iterative loop.

The updated second seismic velocity model may be used to determine synthetic reflection data (i.e., synthetic seismic data that includes reflections 150). To do so, in some embodiments, Born modeling may be used. Born modeling may be a type of forward modeling 415 and may rely on an approximation of Green's function. In some embodiments, synthetic reflection data uₛ may be determined using Born modeling as:

$${u}_{s} ( {x}_{r} , t ; {x}_{s} ) = \int {dt}^{′} δ G ( {x}_{r} , t - {t}^{′} ; {x}_{s} ) f ( {x}_{s} , {t}^{′} ) , where \qquad Equation ( 5 )$$

$$δ G ( {m}_{0} , δ m ) ( {x}_{r} , t ; {x}_{s} ) = - \int \int {dt}^{′} dx {\ddot{G}}_{0} ( x , {t}^{′} ; {x}_{s} ) δ m ( x ) {G}_{0} ( {x}_{r} , t - {t}^{′} ; x ) , \qquad Equation ( 6 )$$

and f(xₛ, t) is the source wavelet. Xu, S., D. Wang, F. Chen, Y. Zhang, and G. Lambare, 2012, Full waveform inversion for reflected seismic data: 74th Annual International Conference and Exhibition, EAGE, Extended Abstracts, W024 may be referenced for further details regarding Born modeling. Because the updated second seismic velocity model may not be accurate, the synthetic reflection data may include kinematic errors. These kinematic errors may ultimately be used to aid in updating the first seismic velocity model 405a later on.

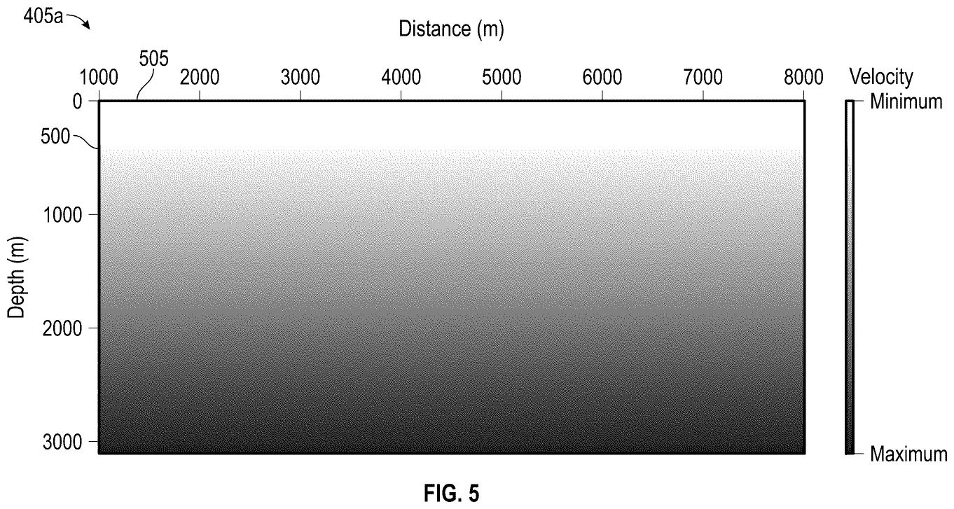

FIG. 6 displays synthetic reflection data 600 in accordance with one or more embodiments. Traveltime is shown along the ordinate 605. Receiver distance from a fixed origin point is shown along the abscissa 610. The grayscale quantifies the amplitude of a pulse 220 where black is a positive amplitude and white is a negative amplitude as shown by the scale bar. Accordingly, gray may be an amplitude near zero. Upon visual comparison of the observed seismic data 300 displayed in FIG. 3 and the synthetic reflection data 600 displayed in FIG. 6, it can be seen that the observed seismic data 300 and synthetic reflection data 600 are dissimilar. For example, the seismic event near the red arrow in FIG. 3 is only minimally present in FIG. 6. Accordingly, the updated second seismic velocity model may not adequately represent the velocity of the seismic waves as they propagate through the subterranean region of interest 105.

In some embodiments, dynamic image warping may be used to determine traveltime shift data between the synthetic reflection data 600 and observed seismic data 300. That is, dynamic image warping may be used to determine the traveltime differences between the synthetic reflection data 600 and observed seismic data 300. The details of dynamic image warping can be found in Hale, D., 2013, Dynamic warping of seismic images: Geophysics, 78, S105-S115 as full discussion of the method of dynamic image warping exceeds the scope of this disclosure.

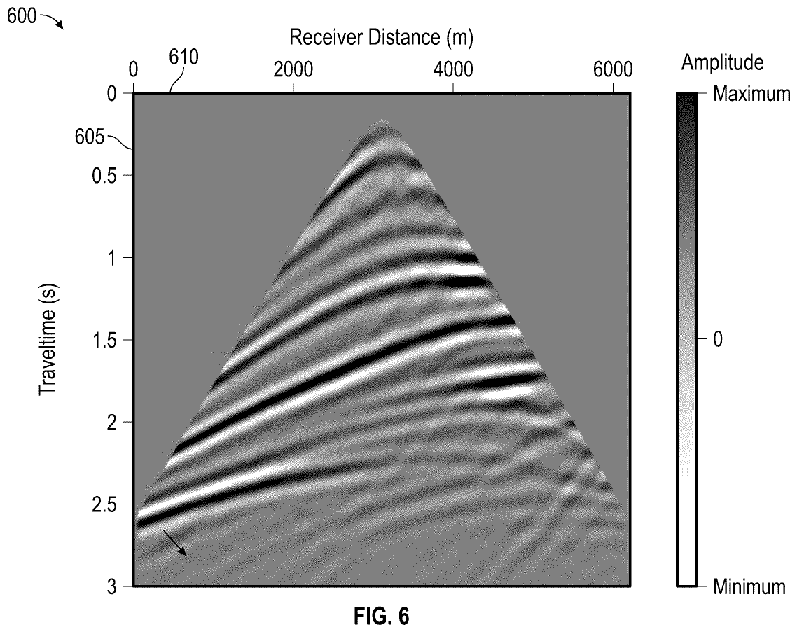

FIG. 7 displays traveltime shift data 700 in accordance with one or more embodiments. Traveltime is shown along the ordinate 705. Receiver distance from a fixed origin point is shown along the abscissa 710. The grayscale quantifies the traveltime shift, in milliseconds (ms), between the synthetic reflection data 600 and observed seismic data 300 as shown by the scale bar.

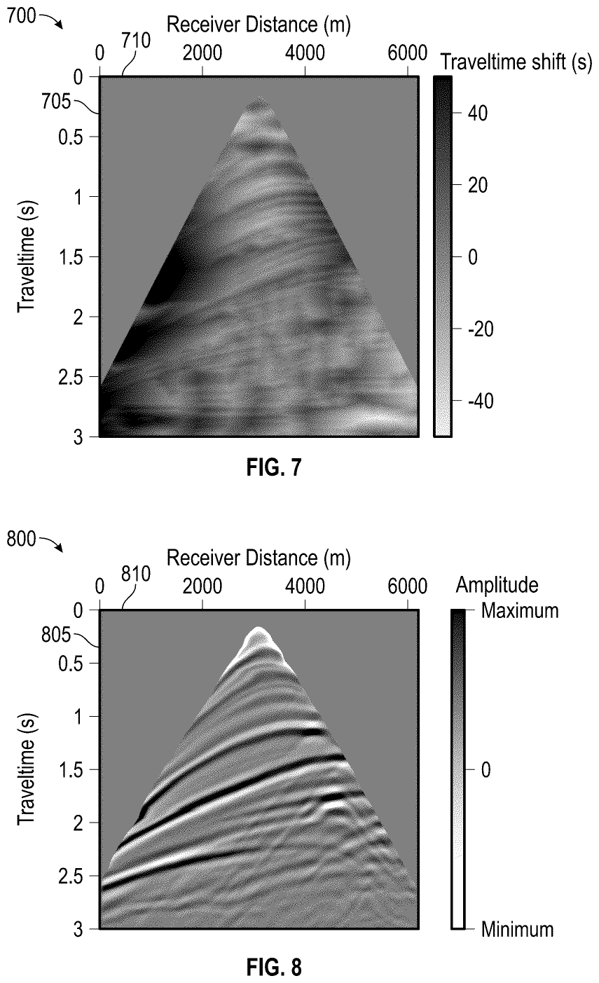

In some embodiments, the traveltime shift data Δτ(t) 700 may be applied to the observed seismic data d(t) 300 to determine warped observed seismic data d(t+Δτ(t)). FIG. 8 displays warped observed seismic data 800 in accordance with one or more embodiments. Traveltime is shown along the ordinate 805. Receiver distance from a fixed origin point is shown along the abscissa 810. The grayscale quantifies the amplitude of a pulse 220 where black is a positive amplitude and white is a negative amplitude as shown by the scale bar. Accordingly, gray may be an amplitude near zero. Ideally, the warped observed seismic data 800 should resemble the synthetic reflection data 600 displayed in FIG. 6. Large differences in amplitude, frequency, and/or number of seismic events, for example, between the observed seismic data 300 and the synthetic reflection data 600 may cause an unreliable determination of the traveltime shift data Δτ(t) 700. Large differences may cause an unreliable determination of an adjoint source and/or cost function 425. Note, the adjoint source may be used to quantify the source wavelet used for modeling the adjoint wavefields, i.e., simulating backpropagating of the seismic waves in time) from a location of a seismic receiver 135. The adjoint wavefields may be used for computing gradients 440. The adjoint source may depend upon a difference or residual between the observed seismic data 300 and synthetic seismic data 420. Unreliable traveltime shift data 700 may lead to differences between the warped observed seismic data 800 and synthetic reflection data 600. Accordingly, the differences may indicate that the traveltime shift data 700 is unreliable.

Unreliable traveltime shift data 700 may lead to gradient and/or updated seismic velocity model 405 artifacts. To mitigate unreliable traveltime shift data 700, local similarity based on shaping regularization may be used to determine conditioned traveltime shift data Δτ′(t) using the synthetic reflection data 600 and the warped observed seismic data 800. To do so, a local similarity attribute, denoted c(t) or, using vector notation, C, may be determined by solving a least-square inversion problem using shaping regularization where:

$${c}^{2} = {c}_{1} ⊙ {c}_{2} = \frac{{SU}^{T} d}{{λ}^{2} I + S ( {U}^{T} U - {λ}^{2} I )} ⊙ \frac{{SD}^{T} u}{{λ}^{2} I + S ( {D}^{T} D - {λ}^{2} I )} , \qquad Equation ( 7 )$$

where d and u are the vector notations for the warped observed seismic data d(t+Δτ(t)) 800 and synthetic reflection data uₛ(t) 600, respectively, D is a diagonal operator composed from the elements of the warped observed seismic data d 800, U is a diagonal operator composed from the elements of the synthetic reflection data u 600, S is a shaping operator, λ is a regularization term, and ⊙ denotes the component-wise product. The local similarity attribute may be a measure of quality of the traveltime shift data Δτ(t) 700.

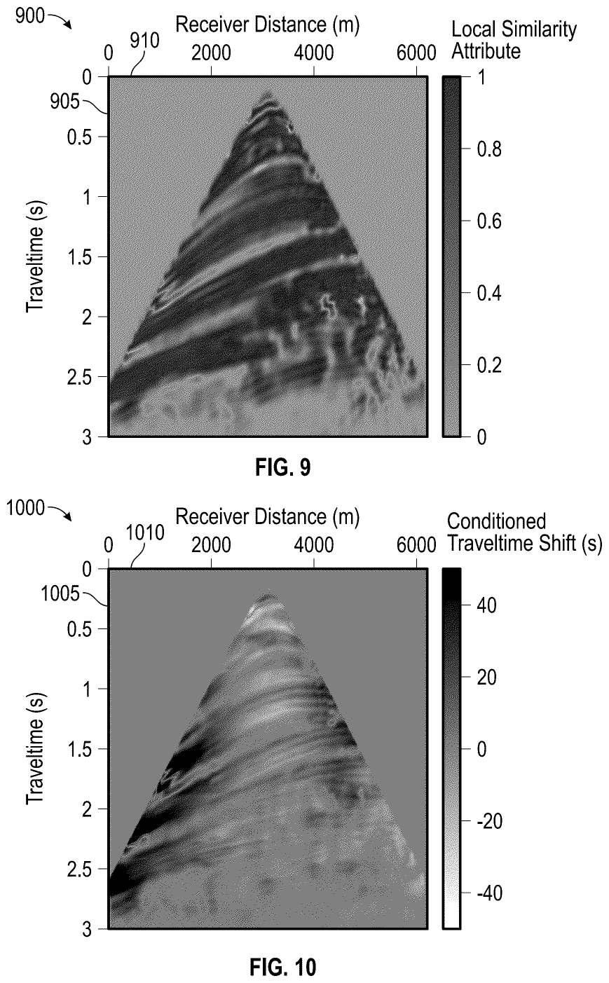

FIG. 9 displays the local similarity attribute 900 in accordance with one or more embodiments. Traveltime is shown along the ordinate 905. Receiver distance from a fixed origin point is shown along the abscissa 910. The grayscale quantifies the local similarity attribute as shown by the scale bar. In these embodiments, the local similarity attribute 900 is determined between the synthetic reflection data 600 displayed in FIG. 6 and warped observed seismic data 800 displayed in FIG. 8. A full discussion of local similarity based on shaping regularization may be found in Fomel, S., 2007, Local seismic attributes, Geophysics, 72, A29-A33.

Following shaping regularization based local similarity, the conditioned traveltime shift data Δτ′(t) are determined as:

$${Δτ}^{′} ( t ) = c ( t ) Δτ ( t ) . \qquad Equation ( 8 )$$

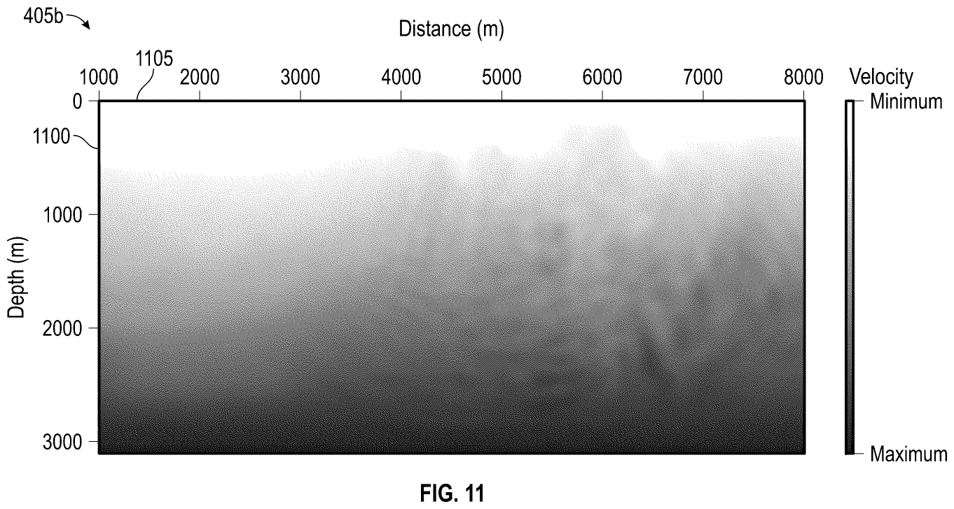

FIG. 10 displays conditioned traveltime shift data 1000 in accordance with one or more embodiments. Traveltime is shown along the ordinate 1005. Receiver distance from a fixed origin point is shown along the abscissa 1010. The grayscale quantifies the conditioned traveltime shift between the synthetic reflection data 600 and observed seismic data 300 as shown by the scale bar.

In some embodiments, traveltime-based RFWI 400 may be performed to update the first seismic velocity model 405a using the conditioned traveltime shift data 1000 between the synthetic reflection data 600 and observed seismic data 300. In some embodiments, the conditioned traveltime shift data 1000 may be used to form a second cost function 425 where:

$${E}_{1} = \frac{1}{2} {\sum }_{{}_{s , r}} {‖ {Δτ}^{′} ( t ) ‖}^{2} , \qquad Equation ( 9 )$$

Specifically, Equation (9) is a least-squares cost function. However, a person of ordinary skill in the art will appreciate that other cost functions 425 may be formed using the conditioned traveltime shift data 1000.

During traveltime-based RFWI 400, if the stopping criterion is not satisfied, a second gradient 440 is used to perturb the first seismic velocity model 405a. In some embodiments, the second gradient 440 may be:

$${g}_{{m}_{0}} = \int \int \int {dx}_{s} {dx}_{r} dt [ \text{} δ \dot{G} ( x , t ; {x}_{s} ) ( {\dot{G}}_{0} ( x , - t ; {x}_{r} ) * δ s ) + {\dot{G}}_{0} ( x , t ; {x}_{s} ) \text{} ( δ \text{} \dot{G} ( x , - t ; {x}_{r} ) * δ s ) ] , \qquad Equation ( 10 )$$

where the adjoint source δs is:

$$δ s = \frac{Δτ ( t ) \dot{d} ( t + {Δτ}^{′} ( t ) )}{\begin{matrix}\int dt [ \ddot{d} ( t + {Δτ}^{′} ( t ) ) ( {u}_{s} ( t ) - d ( t + {Δτ}^{′} ( t ) ) ) - \\ {\dot{d}}^{2} ( t + {Δτ}^{′} ( t ) ) ]\end{matrix}} . \qquad Equation ( 11 )$$

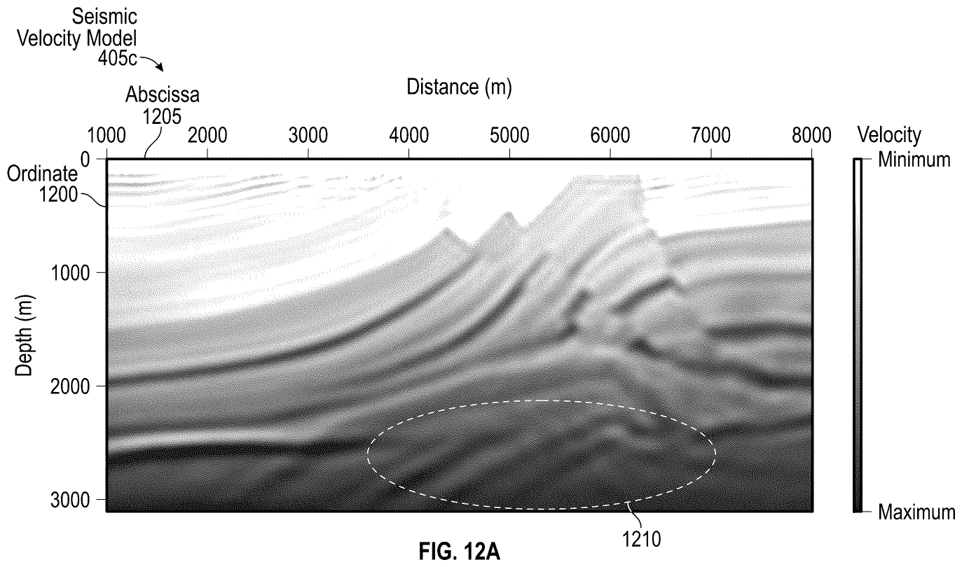

FIG. 11 displays an updated first seismic velocity model 405b in accordance with one or more embodiments. Depth is shown along the ordinate 1100. Distance is shown along the abscissa 1105. The grayscale quantifies the velocity as shown by the scale bar.

In some embodiments, the method of updating the second seismic velocity model and first seismic velocity model 405a may be iterative. That is, forward modeling 415 may be applied to the updated first seismic velocity model 405b (determined using traveltime-based RFWI 400 that relies on the second cost function 425 and second gradient 440) to determine updated synthetic seismic data 420 and the method described above repeated.

Once a stopping criterion is satisfied and the method described above ends, in some embodiments, the updated first seismic velocity model 405b may be used as an initial seismic velocity model m that includes the first seismic velocity model and second seismic velocity model. In some embodiments, conventional FWI 400 may be performed to update the seismic velocity model using tens to hundreds of iterations. For example, the cost function shown in Equation (2) and the gradient given by Equation (4) may be used for this step.

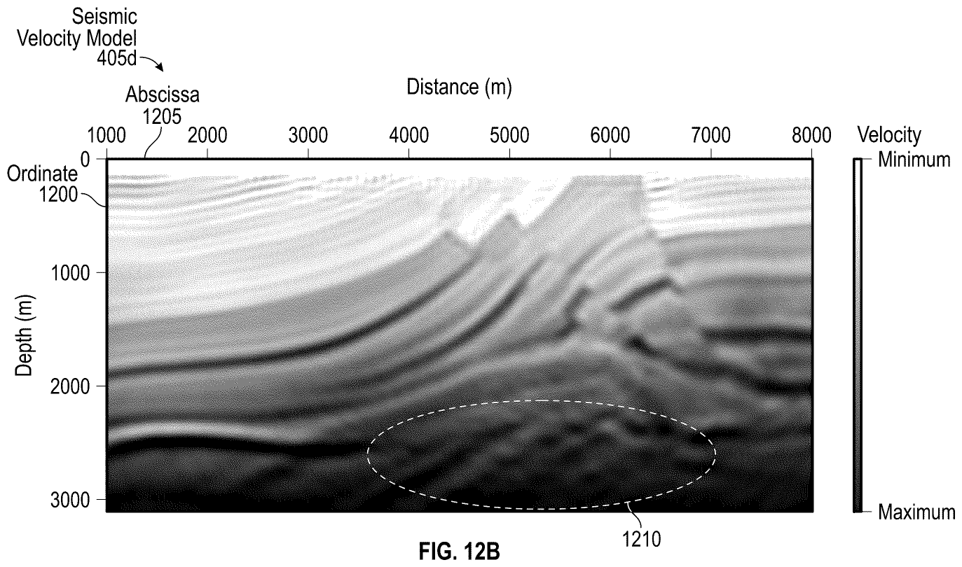

FIG. 12A displays an updated seismic velocity model 405c in accordance with one or more embodiments. Depth is shown along the ordinate 1200. Distance is shown along the abscissa 1205. The grayscale quantifies the velocity as shown by the scale bar. The updated seismic velocity model 405c may be considered a high-resolution seismic velocity model m. For comparison, FIG. 12B displays a seismic velocity model 405d obtained using a conventional method, specifically a method that omits the steps of determining the warped observed seismic data and conditioning traveltime shift using local similarity based on shaping regularization. Focusing on the area indicated by the ellipse 1210, it is clear that the reflectors at the base of the model are more focused in the result produced by the inventive process, i.e., updated seismic velocity model 405c, than in the result produced by the example conventional process, i.e., updated seismic velocity model 405d.

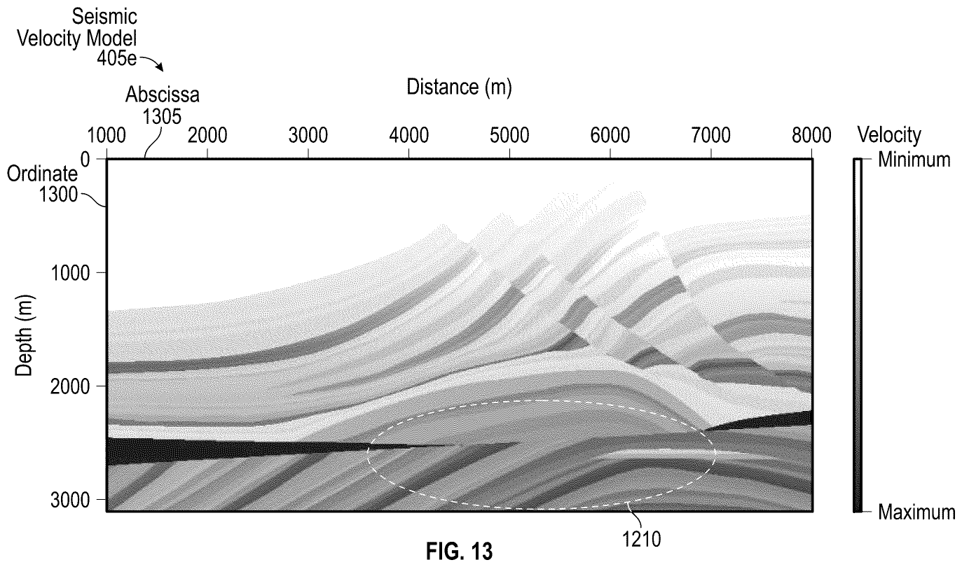

This improvement may be verified by inspection of the corresponding interfaces in FIG. 13 that displays the ground truth seismic velocity model 405e in accordance with one or more embodiments. Specifically, the ground truth seismic velocity model 405e is modified from the Marmousi model. Depth is shown along the ordinate 1300. Distance is shown along the abscissa 1305. The grayscale quantifies the velocity as shown by the scale bar. Upon a visual comparison of FIGS. 12 and 13, it can be seen that the seismic velocity model 405c of FIG. 12 is similar to the ground truth seismic velocity model 405e of FIG. 13.

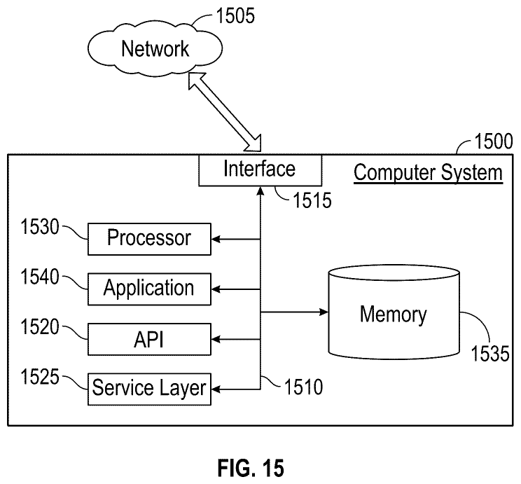

FIG. 14 summarizes a method in accordance with one or more embodiments. In step 1400, observed seismic data 300 is received by a seismic processing system from a seismic acquisition system 125. The observed seismic data 300 pertains to a subterranean region of interest 105. The seismic acquisition system 125 may be configured to perform a seismic survey 100 over the subterranean region of interest 105 as described relative to FIG. 1. FIG. 3 displays observed seismic data 300 in accordance with one or more embodiments. The seismic processing system is described in detail relative to FIG. 15.

In step 1405, a first seismic velocity model 405a of the subterranean region of interest 105 is received by the seismic processing system. The first seismic velocity model 405a may be similar to the first seismic velocity model 405a displayed in FIG. 5. In some embodiments, the first seismic velocity model 405a may be a low-wavenumber seismic velocity model.

In step 1410, a second seismic velocity model of the subterranean region of interest 105 may be received by the seismic processing system. Typically, the second seismic model may have an initial value of zero at every location within the subterranean region of interest. However, in some embodiments, the second seismic velocity model may be a high-wavenumber seismic velocity model obtained from interpolating and/or extrapolating well log information from wells penetrating the subterranean region of interest, or from previously completed seismic imaging studies.

In some embodiments, steps 1415, 1420, 1425, 1430, 1435, 1440, and 1445 may be performed iteratively by the seismic processing system.

In step 1415, synthetic seismic data 420 is determined using the first seismic velocity model 405a. To do so, in some embodiments, forward modeling 415 may be applied to the first seismic velocity model 405a to determine the synthetic seismic data 420 as described relative to FIG. 4. In some embodiments, the synthetic seismic data 420 may not include any reflections 150.

In step 1420, an updated second seismic velocity model is determined using the observed seismic data 300 received in step 1400, the second seismic velocity model received in step 1410, and the synthetic seismic data 420 determined in step 1415. To do so, in some embodiments, conventional FWI 400 may determine the updated second seismic velocity model as described relative to FIG. 4. In some embodiments, the first cost function 425 given in Equation (2) may compare the observed seismic data 300 and synthetic seismic data 420. In some embodiments, the first gradient given in Equation (4) may determine the direction and rate of perturbation to update the second seismic velocity model based on the first cost function 425. Once the first stopping criterion is satisfied, the first cost function 425 and updated second seismic velocity model may be considered to have converged to a first extremum. In some embodiments, only a few iterations may be performed during step 1420. Accordingly, the updated second seismic velocity model may not be accurate.

In step 1425, synthetic reflection data 600 is determined using the updated second seismic velocity model determined in step 1420. To do so, in some embodiments, Born modeling, a type of forward modeling 415, may be used as described relative to Equations (5) and (6). FIG. 6 displays synthetic reflection data 600 in accordance with one or more embodiments.

In step 1430, traveltime shift data 700 is determined between the synthetic reflection data 600 determined in step 1425 and the observed seismic data 300 received in step 1400. To do so, in some embodiments, dynamic image warping may be used. FIG. 7 displays traveltime shift data 700 in accordance with one or more embodiments.

In step 1435, warped observed seismic data 800 is determined by applying the traveltime shift data 700 determined in step 1430 to the observed seismic data 300 received in step 1400. FIG. 8 displays warped observed seismic data 800 in accordance with one or more embodiments.

In step 1440, conditioned traveltime shift data 1000 is determined using the synthetic reflection data 600 determined in step 1425, the warped observed seismic data 800 determined in step 1435, and the traveltime shift data 700 determined in step 1430. In some embodiments, local similarity attribute 900 based on shaping regularization may be used to determine the conditioned traveltime shift data 1000 described relative to Equation (7) and displayed in FIG. 9. The conditioned traveltime shift data 1000 may then be determined using Equation (8). FIG. 10 displays conditioned traveltime shift data 1000 in accordance with one or more embodiments.

In step 1445, an updated first seismic velocity model 405b is determined using the first seismic velocity model 405a received in step 1405 and the conditioned traveltime shift data 1000 determined in step 1440. To do so, in some embodiments, traveltime-based RFWI 400 may determine the updated first seismic velocity model 405b. In some embodiments, the second cost function 425 given in Equation (9) may be used that relies on the conditioned traveltime shift data 1000. In some embodiments, the second gradient 440 given in Equation (10) may be used to determine the direction and rate of perturbation to update the first seismic velocity model 405b based on the second cost function 425. FIG. 11 displays an updated first seismic velocity model 405b in accordance with one or more embodiments. Once the second stopping criterion is satisfied, the second cost function 425 and updated first seismic velocity model 405b may be considered to have converged to a second extremum.

Steps 1415, 1420, 1425, 1430, 1435, 1440, and 1445 may be repeated iterative until a stopping criterion is satisfied. Once the stopping criterion is satisfied, step 1450 may be performed. In step 1450, a seismic velocity model 405c is determined using the updated first seismic velocity model 405b determined in step 1445. To do so, in some embodiments, conventional FWI 400 may determine the seismic velocity model 405c where the updated first seismic velocity model 405b is used as the initial seismic velocity model for conventional FWI 400. FIG. 12 displays a seismic velocity model 405c in accordance with one or more embodiments. Once a third stopping criterion is satisfied, a third cost function 425 and the seismic velocity model 405c may be considered to have converged to a third extremum where a third gradient determined the direction and rate of perturbation to update the seismic velocity model 405c.

In step 1455, a seismic image of the subterranean region of interest 105 may be determined using the observed seismic data 300 received in step 1400 and the seismic velocity model 405c determined in step 1450. That is, the seismic velocity model 405c may be applied to the observed seismic data 300 to transform the observed seismic data 300 from a time domain to a depth domain. A person of ordinary skill in the art will appreciate that other routine seismic processing steps may also be performed to determine the seismic image without departing from the scope of the disclosure.

In step 1460, a location of a hydrocarbon reservoir 120 is determined within the subterranean region of interest 105 using the seismic image determined in step 1455. In some embodiments, the seismic image may be displayed or rendered on a seismic interpretation workstation. A seismic interpreter may manipulate the displayed seismic image, in two or three dimensions, using the seismic interpretation workstation to locate the location of the hydrocarbon reservoir 120 within the subterranean region of interest 105. The seismic interpretation workstation is described in detail relative to FIG. 15.

In some embodiments, step(s) 1465 and/or 1470 may be performed. In step 1465, a wellbore drilling plan may be designed based on the location of the hydrocarbon reservoir 120 within the subterranean region of interest 105. In some embodiments, the wellbore drilling plan may include coordinates of a wellbore path that penetrates the location of the hydrocarbon reservoir 120.

In step 1470, a wellbore guided by the wellbore drilling plan may be drilled, using a drilling system. The wellbore may penetrate the hydrocarbon reservoir 120 within the subterranean region of interest 105.

Advantageously, various embodiments of the methods described above may be an improvement over other methods used to determine the updated first seismic velocity model 405b, updated second seismic velocity model, and/or updated seismic velocity model 405c. While other methods may rely on FWI 400, other methods may not do so in an iterative manner based on conditioned traveltime shift data 1000 determined using local similarity based on shaping regularization as the methods described above do. The use of dynamic image warping may also be an improvement as other methods may use a windowed cross-correlation method to determine and condition or weight the traveltime shift data 700. The windowed cross-correlation method may require a time window to be determined, which may not be straightforward, whereas dynamic image warping does not require a time window. Accordingly, cycle skipping may be mitigated and a more accurate seismic velocity model 405c determined using the methods described above. Therefore, the seismic velocity model 405c may more accurately transform the observed seismic data 300 from a time domain to a depth domain such that a hydrocarbon reservoir 120 within a subterranean region of interest 105 may be more accurately located, a wellbore drilling plan better designed, and a wellbore drilled to produce prolific hydrocarbons.

FIG. 15 illustrates a computer system 1500 in accordance with one or more embodiments. In some embodiments, the computer system 1500 may be specifically configured for seismic processing and denoted a “seismic processing system.” Additionally, or alternatively, the computer system 1500 may be specifically configured for seismic interpretation and denoted a “seismic interpretation workstation.” Further, in other embodiments, the seismic acquisition system 125, seismic processing system, seismic interpretation workstation, wellbore planning system, and/or drilling system may include a computer system 1500. While the term computer system 1500 may be used to describe each of the parts of a computer system 1500 in the following paragraphs, the terms seismic processing system or seismic interpretation workstation may replace the term computer system 1500 without departing from the scope of the disclosure.

The computer system 1500 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system 1500 may include an input device, such as a keypad, keyboard, touch screen, or other device that can accept user information, and an output device that displays information, including digital data, visual or audio information (or a combination of both), or a graphical user interface (GUI). Specifically, a seismic interpretation workstation may include a robust graphics card for the detailed rendering of the seismic image such that the seismic image may be displayed and manipulated by a seismic interpreter in a virtual reality system using 3D goggles, a mouse, or a wand to determine the location of the hydrocarbon reservoir 120 within the subterranean region of interest 105.

The computer system 1500 can serve in a role as a client, network component, server, database, or any other component (or a combination of roles) of a computer system 1500 as required for seismic processing and seismic interpretation. The illustrated computer system 1500 is communicably coupled with a network 1505. For example, a seismic processing system and seismic interpretation workstation may be communicably coupled via the network 1505. In some implementations, one or more components of each computer system 1500 may be configured to operate within environments, including cloud-computing-based, local, global, or other environment (or a combination of environments).

At a high level, the computer system 1500 is an electronic computing device operable to receive, transmit, process, store, and/or manage data and information associated with the disclosed methods. According to some implementations, the computer system 1500 may also include or be communicably coupled with an application server, e-mail server, web server, caching server, streaming data server, business intelligence (BI) server, or other server (or a combination of servers).

Because seismic processing and seismic interpretation may not be sequential, the computer system 1500 can receive requests over the network 1505 from other computer systems 1500 or another client application and respond to the received requests by processing the requests appropriately. In addition, requests may also be sent to the computer system 1500 from internal users (for example, from a command console or by other appropriate access method), external or third-parties, other automated applications, as well as any other appropriate entities, individuals, systems, or computer systems 1500.

Each of the components of the computer system 1500 can communicate using a system bus 1510. In some implementations, any or all of the components of each computer system 1500, both hardware or software (or a combination of hardware and software), may interface with each other or the interface 1515 (or a combination of both) over the system bus 1510 using an application programming interface (API) 1520 or a service layer 1525 (or a combination of the API 1520 and service layer 1525. The API 1520 may include specifications for routines, data structures, and object classes. The API 1520 may be either computer-language independent or dependent and refer to a complete interface, a single function, or even a set of APIs. The service layer 1525 provides software services to each computer system 1500 or other components (whether or not illustrated) that are communicably coupled to each computer system 1500. The functionality of each computer system 1500 may be accessible for all service consumers using this service layer 1525. Software services, such as those provided by the service layer 1525, provide reusable, defined business functionalities through a defined interface. For example, the interface may be software written in JAVA, C++, or other suitable language providing data in extensible markup language (XML) format or another suitable format. While illustrated as an integrated component of each computer system 1500, alternative implementations may illustrate the API 1520 or the service layer 1525 as stand-alone components in relation to other components of each computer system 1500 or other components (whether or not illustrated) that are communicably coupled to each computer system 1500. Moreover, any or all parts of the API 1520 or the service layer 1525 may be implemented as child or sub-modules of another software module, enterprise application, or hardware module without departing from the scope of this disclosure.

The computer system 1500 includes an interface 1515. Although illustrated as a single interface 1515 in FIG. 15, two or more interfaces 1515 may be used according to particular needs, desires, or particular implementations of each computer system 1500. The interface 1515 is used by each computer system 1500 for communicating with other systems in a distributed environment that are connected to the network 1505. Generally, the interface 1515 includes logic encoded in software or hardware (or a combination of software and hardware) and operable to communicate with the network 1505. More specifically, the interface 1515 may include software supporting one or more communication protocols associated with communications such that the network 1505 or interface's hardware is operable to communicate physical signals within and outside of the illustrated computer system 1500.

The computer system 1500 includes at least one computer processor 1530. Generally, a computer processor 1530 executes any instructions, algorithms, methods, functions, processes, flows, and procedures as described above. A computer processor 1530 may be a central processing unit (CPU) and/or a graphics processing unit (GPU). The observed seismic data 300 may be tens to hundreds of terabytes or even petabytes in size. To efficiently perform the method described in FIG. 14 to determine the seismic image, a seismic processing system may consist of an array of CPUs with one or more subarrays of GPUs attached to each CPU. Further, tape readers or high-capacity hard-drives may be connected to the CPUs using wide-band system buses 1510.

The computer system 1500 also includes a memory 1535, i.e., a non-transitory computer readable medium, that stores data and software, i.e., computer-executable instructions, for the computer system 1500 or other components (or a combination of both) that can be connected to the network 1505. In some embodiments, the memory 1535 may store the observed seismic data 300, first seismic velocity model 405a, and second seismic velocity model. In some embodiments, the memory 1535 may store a wellbore planning system in the form of software. In some embodiments, the wellbore planning system may be configured to design the wellbore drilling plan, which includes the wellbore path based, at least in part, on the location of the hydrocarbon reservoir 120. Although illustrated as a single memory 1535 in FIG. 15, two or more memories 1535 may be used according to particular needs, desires, or particular implementations of the computer system 1500 and the described functionality. While memory 1535 is illustrated as an integral component of each computer system 1500, in alternative implementations, memory 1535 can be external to each computer system 1500.

The application 1540 is an algorithmic software engine providing functionality according to particular needs, desires, or particular implementations of the computer system 1500, particularly with respect to functionality described in this disclosure. For example, application 1540 can serve as one or more components, modules, applications, etc. Further, although illustrated as a single application 1540, the application 1540 may be implemented as multiple applications 1540 on each computer system 1500. In addition, although illustrated as integral to each computer system 1500, in alternative implementations, the application 1540 can be external to each computer system 1500.

There may be any number of computer systems 1500, such as computer clusters, associated with, or external to, a seismic processing system and seismic interpretation workstation, where each computer system 1500 communicates over the network 1505. Further, the term “client,” “user,” and other appropriate terminology may be used interchangeably as appropriate without departing from the scope of this disclosure. Moreover, this disclosure contemplates that many users may use the computer system 1500, or that one user may use multiple computer systems 1500.

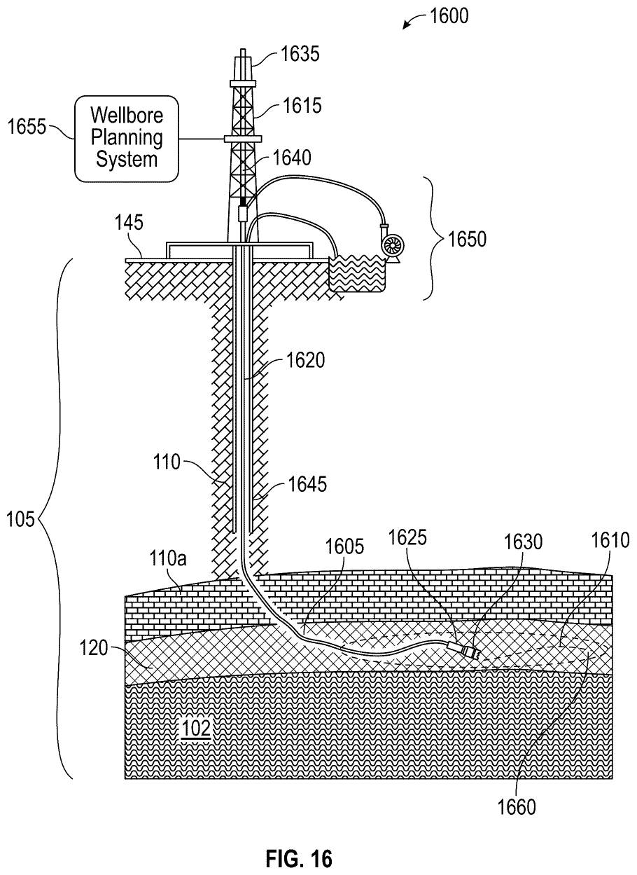

FIG. 16 illustrates a drilling system 1600 in accordance with one or more embodiments. In some embodiments, following steps 1400, 1405, 1410, 1415, 1420, 1425, 1430, 1435, 1440, 1445, 1450, 1455, 1460, and 1465 as described relative to FIG. 14, the drilling system 1600 may be configured to drill a wellbore 1605 within the subterranean region of interest 105 guided by the wellbore drilling plan, which includes a wellbore path 1610. In some embodiments, the wellbore drilling plan may be designed such that the wellbore path 1610 penetrates the location of the hydrocarbon reservoir 120 within the subterranean region of interest 105.

Although the drilling system 1600 shown in FIG. 16 is used to drill the wellbore 1605 on land, the drilling system 1600 may be a marine wellbore drilling system. Further, although the drilling system 1600 shown in FIG. 16 is used to drill a new wellbore 1605, the wellbore 1605 being drilled may be a sidetrack wellbore or an offset wellbore. As such, the example of the drilling system 1600 shown in FIG. 16 is not meant to limit the present disclosure.

As shown in FIG. 16, the wellbore 1605 may be drilled using a drill rig situated on a land drill site, an offshore platform, such as a jack-up rig, a semi-submersible, or a drill ship. The drill rig may be equipped with a hoisting system, such as a derrick 1615, which can raise or lower the drillstring 1620 and other tools required to drill the wellbore 1605. The drillstring 1620 may include one or more drill pipes connected to form conduit and a bottom hole assembly 1625 (BHA) disposed at the distal end of the drillstring 1620. The BHA 1625 may include a drill bit 1630 to cut into rock 110, including cap rock 110a. The BHA 1625 may further include measurement tools, such as a measurement-while-drilling (MWD) tool and logging-while-drilling (LWD) tool. MWD tools may include sensors and hardware to measure downhole drilling parameters, such as the azimuth and inclination of the drill bit 1630, the weight-on-bit, and the torque. The LWD measurements may include sensors, such as resistivity, gamma ray, and neutron density sensors, to characterize the rock 110 surrounding the wellbore 1605. Both MWD and LWD measurements may be transmitted to the surface of the earth 145 using any suitable telemetry system known in the art, such as a mud-pulse or by wired-drill pipe.

To start drilling, or “spudding in,” the wellbore 1605, the hoisting system lowers the drillstring 1620 suspended from the derrick 1615 of the drill rig towards the planned surface location of the wellbore 1605. An engine, such as a diesel engine, may be used to supply power to the top drive 1635 to rotate the drillstring 1620 via the drive shaft 1640. The weight of the drillstring 1620 combined with the rotational motion enables the drill bit 1630 to bore the wellbore 1605.

The near-surface rock 110 of the subterranean region of interest 105 is typically made up of loose or soft sediment or rock, so large diameter casing 1645 (e.g., “base pipe” or “conductor casing”) is often put in place while drilling to stabilize and isolate the wellbore 1605. At the top of the base pipe is the wellhead (not shown), which serves to provide pressure control through a series of spools, valves, or adapters. Once near-surface drilling has begun, water or drill fluid may be used to force the base pipe into place using a pumping system until the wellhead is situated just above the surface of the earth 145.

Drilling may continue without any casing 1645 once deeper or more compact rock 110 is reached. While drilling, a drilling mud system 1650 may pump drilling mud from a mud tank on the surface of the earth 145 through the drill pipe. Drilling mud serves various purposes, including pressure equalization, removal of rock cuttings, and drill bit cooling and lubrication.

At planned depth intervals, drilling may be paused and the drillstring 1620 withdrawn from the wellbore 1605. Sections of casing 1645 may be connected, inserted, and cemented into the wellbore 1605. Casing string may be cemented in place by pumping cement and mud, separated by a “cementing plug,” from the surface of the earth 145 through the drill pipe. The cementing plug and drilling mud force the cement through the drill pipe and into the annular space between the casing 1645 and the wall of the wellbore 1605. Once the cement cures, drilling may recommence. The drilling process is often performed in several stages. Therefore, the drilling and casing cycle may be repeated more than once, depending on the depth of the wellbore 1605 and the pressure on the walls of the wellbore 1605 from surrounding rock 110.

Due to the high pressures experienced by deep wellbores 1605, a blowout preventer (BOP) may be installed at the wellhead to protect the rig and environment from unplanned oil or gas releases. As the wellbore 1605 becomes deeper, both successively smaller drill bits 1630 and casing 1645 may be used. Drilling deviated or horizontal wellbores 1605 may require specialized drill bits 1630 or drill assemblies.

The drilling system 1600 may be disposed at and communicate with other systems in the wellbore environment, such as the wellbore planning system 1655. The drilling system 1600 may control at least a portion of a drilling operation by providing controls to various components of the drilling operation. In one or more embodiments, the drilling system 1600 may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target 1660 with the hydrocarbon reservoir 120 is reached or the presence of hydrocarbons is established.

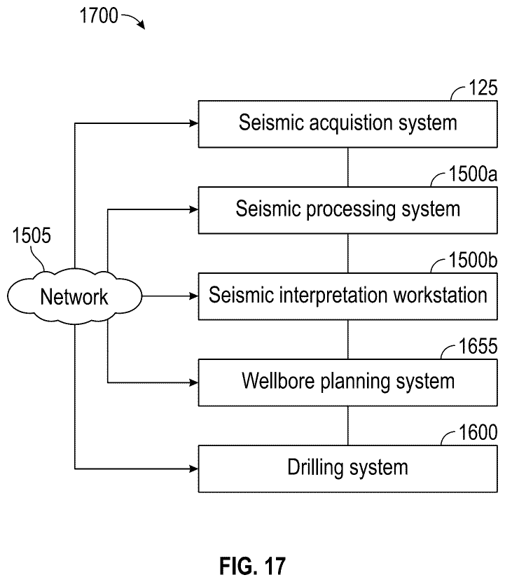

FIG. 17 describes a system 1700 in accordance with one or more embodiments. The system 1700 may include at least two of a seismic acquisition system 125, seismic processing system 1500a, seismic interpretation workstation 1500b, wellbore planning system 1655, and drilling system 1600. Each part of the system 1700 may be communicably coupled with any other part of the system 1700 via the network 1505. The seismic acquisition system 125, seismic processing system 1500a, seismic interpretation workstation 1500b, wellbore planning system 1655, and/or drilling system 1600 may include a computer system 1500. In some embodiments, the seismic processing system 1500a and/or seismic interpretation workstation 1500b may be a computer system 1500.

In some embodiments, the seismic acquisition system 125 may be configured to obtain the observed seismic data 300 from the subterranean region of interest 105 as described relative to FIG. 1. The observed seismic data 300 may be transferred from the seismic acquisition system 125 to the seismic processing system 1500a. The seismic processing system 1500a may receive and store the observed seismic data 300. In some embodiments, seismic processing system 1500a may receive the first seismic velocity model 405a and second seismic velocity model.

In some embodiments, the seismic processing system 1500a may be configured to perform steps 1415, 1420, 1425, 1430, 1435, 1440, 1445, 1450, and 1455 as described relative to FIG. 14 to ultimately determine a seismic image.

The seismic image may be transferred to and stored on the seismic interpretation workstation 1500b. In some embodiments, the seismic interpretation workstation 1500b may be configured to perform step 1460 as described relative to FIG. 14 to determine a location of a hydrocarbon reservoir 120 within the subterranean region of interest 105.

In some embodiments, the location of the hydrocarbon reservoir 120 may be transferred to, stored on, and processed by the wellbore planning system 1655. In some embodiments, the wellbore planning system 1655 may be or include a computer system 1500. In these embodiments, the computer system 1500 may include specific software used for wellbore planning. The wellbore planning system 1655 may be configured to design a wellbore drilling plan based, at least in part, on the location of the hydrocarbon reservoir 120. In some embodiments, the wellbore drilling plan may be designed such that the wellbore path 1610 drills through the location of the hydrocarbon reservoir 120 within the subterranean region of interest 105.

In some embodiments, the wellbore drilling plan may be transferred to and stored by the drilling system 1600. The drilling system 1600 may be configured to drill the wellbore 1605 within the subterranean region of interest 105 guided by the wellbore drilling plan as illustrated in FIG. 16.

In summary, the methods and systems described may rely on multiple forms of FWI 400 to iteratively determine an updated first seismic velocity model 405b and updated second seismic velocity model. In some embodiments, the updated first seismic velocity model 405b may be used as an initial seismic velocity model 405c that includes a first seismic velocity model 405b and second seismic velocity model. The initial seismic velocity model 405c may be updated using FWI 400. The updated seismic velocity model 405c may then be used to transform observed seismic data 300 from a time domain to a depth domain to determine a seismic image.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
using a seismic processing system:
receiving, from a seismic acquisition system, observed seismic data pertaining to a subterranean region of interest,
receiving a first seismic velocity model of the subterranean region of interest,
receiving a second seismic velocity model of the subterranean region of interest, iteratively or recursively, until a stopping criterion is satisfied:
determining synthetic seismic data based, at least in part, on the first seismic velocity model;
determining an updated second seismic velocity model based, at least in part, on the second seismic velocity model, the observed seismic data, and the synthetic seismic data;
determining synthetic reflection data based, at least in part, on the updated second seismic velocity model;
determining, using dynamic image warping, traveltime shift data between the synthetic reflection data and the observed seismic data;
determining warped observed seismic data by applying the traveltime shift data to the observed seismic data;
determining, using local similarity based on shaping regularization, conditioned traveltime shift data based, at least in part, on the synthetic reflection data, the warped observed seismic data, and the traveltime shift data; and
determining an updated first seismic velocity model based, at least in part, on the first seismic velocity model and the conditioned traveltime shift data,
determining a seismic velocity model of the subterranean region of interest based, at least in part, on the updated first seismic velocity model, and
determining a seismic image based, at least in part, on the observed seismic data and the seismic velocity model; and
determining, using a seismic interpretation workstation, a location of a hydrocarbon reservoir within the subterranean region of interest using, at least in part, the seismic image.

2. The method of claim 1, further comprising designing, using a wellbore planning system, a wellbore drilling plan based, at least in part, on the location of the hydrocarbon reservoir.

3. The method of claim 2, further comprising drilling, using a drilling system, a wellbore that penetrates the location of the hydrocarbon reservoir based, at least in part, on the wellbore drilling plan.

4. The method of claim 1, wherein determining the updated second seismic velocity model comprises:
iteratively or recursively, until a first stopping criterion is satisfied:
forming a first cost function based, at least in part, on the observed seismic data and the synthetic seismic data,
determining a first gradient based on the first cost function, and
perturbing the second seismic velocity model based, at least in part, on the first gradient.

5. The method of claim 4, wherein the first cost function comprises a least-squares cost function.

6. The method of claim 1, wherein determining the synthetic reflection data comprises applying Born modeling.

7. The method of claim 1, wherein determining the updated first seismic velocity model comprises:
iteratively or recursively, until a second stopping criterion is satisfied:
forming a second cost function based, at least in part, on the conditioned traveltime shift data,
determining a second gradient based on the second cost function, and
perturbing the first seismic velocity model based, at least in part, on the second gradient.

8. The method of claim 1, wherein determining the seismic velocity model comprises:
iteratively or recursively, until a third stopping criterion is satisfied:
forming a third cost function based, at least in part, on the observed seismic data and the synthetic seismic data,
determining a third gradient based on the third cost function, and
perturbing the updated first seismic velocity model based, at least in part, on the third gradient.

9. The method of claim 1, wherein using the shaping regularization comprises determining a local similarity attribute between the synthetic reflection data and the warped observed seismic data.

10. The method of claim 1, wherein the first seismic velocity model comprises a low-wavenumber seismic velocity model.

11. A system comprising:
a seismic processing system configured to:
receive, from a seismic acquisition system, observed seismic data pertaining to a subterranean region of interest,
receive a first seismic velocity model of the subterranean region of interest,
receive a second seismic velocity model of the subterranean region of interest, iteratively or recursively, until a stopping criterion is satisfied:
determine synthetic seismic data based, at least in part, on the first seismic velocity model;
determine an updated second seismic velocity model based, at least in part, on the second seismic velocity model, the observed seismic data, and the synthetic seismic data;
determine synthetic reflection data based, at least in part, on the updated second seismic velocity model;
determine, using dynamic image warping, traveltime shift data between the synthetic reflection data and the observed seismic data;
determine warped observed seismic data by applying the traveltime shift data to the observed seismic data;
determine, using local similarity based on shaping regularization, conditioned traveltime shift data based, at least in part, on the synthetic reflection data, the warped observed seismic data, and the traveltime shift data; and
determine an updated first seismic velocity model based, at least in part, on the first seismic velocity model and the conditioned traveltime shift data,
determine a seismic velocity model of the subterranean region of interest based, at least in part, on the updated first seismic velocity model, and
determine a seismic image based, at least in part, on the observed seismic data and the seismic velocity model; and
a seismic interpretation workstation configured to determine a location of a hydrocarbon reservoir within the subterranean region of interest using, at least in part, the seismic image.

12. The system of claim 11, further comprising a wellbore planning system configured to design a wellbore drilling plan based, at least in part, on the location of the hydrocarbon reservoir.

13. The system of claim 12, further comprising a drilling system configured to drill a wellbore that penetrates the location of the hydrocarbon reservoir based, at least in part, on the wellbore drilling plan.

14. The system of claim 11, further comprising the seismic acquisition system configured to obtain the observed seismic data.

15. A non-transitory computer-readable memory having computer-executable instructions stored thereon that, when executed by a computer processor, perform steps comprising:
receiving, from a seismic acquisition system, observed seismic data pertaining to a subterranean region of interest;
receiving a first seismic velocity model of the subterranean region of interest;
receiving a second seismic velocity model of the subterranean region of interest;
iteratively or recursively, until a stopping criterion is satisfied:
determining synthetic seismic data based, at least in part, on the first seismic velocity model,
determining an updated second seismic velocity model based, at least in part, on the second seismic velocity model, the observed seismic data, and the synthetic seismic data,
determining synthetic reflection data based, at least in part, on the updated second seismic velocity model,
determining, using dynamic image warping, traveltime shift data between the synthetic reflection data and the observed seismic data,
determining warped observed seismic data by applying the traveltime shift data to the observed seismic data,
determining, using local similarity based on shaping regularization, conditioned traveltime shift data based, at least in part, on the synthetic reflection data, the warped observed seismic data, and the traveltime shift data, and
determining an updated first seismic velocity model based, at least in part, on the first seismic velocity model and the conditioned traveltime shift data;
determining a seismic velocity model of the subterranean region of interest based, at least in part, on the updated first seismic velocity model;
determining a seismic image based, at least in part, on the observed seismic data and the seismic velocity model; and
determining a location of a hydrocarbon reservoir within the subterranean region of interest using, at least in part, the seismic image.

16. The non-transitory computer-readable memory of claim 15, further comprising designing a wellbore drilling plan based, at least in part, on the location of the hydrocarbon reservoir.

17. The non-transitory computer-readable memory of claim 15, wherein determining the updated second seismic velocity model comprises:
iteratively, until a first stopping criterion is satisfied:
forming a first cost function based, at least in part, on the observed seismic data and the synthetic seismic data,
determining a first extremum of the first cost function, and
perturbing the second seismic velocity model based, at least in part, on the first extremum.

18. The non-transitory computer-readable memory of claim 15, wherein determining the updated first seismic velocity model comprises:
iteratively, until a second stopping criterion is satisfied:
forming a second cost function based, at least in part, on the conditioned traveltime shift data,
determining a second extremum of the second cost function, and
perturbing the first seismic velocity model based, at least in part, on the second extremum.

19. The non-transitory computer-readable memory of claim 15, wherein determining the seismic velocity model comprises:
iteratively, until a third stopping criterion is satisfied:
forming a third cost function based, at least in part, on the observed seismic data and the synthetic seismic data,
determining a third extremum of the third cost function, and
perturbing the updated first seismic velocity model based, at least in part, on the third extremum.

20. The non-transitory computer-readable memory of claim 15, wherein using the shaping regularization comprises determining a local similarity attribute between the synthetic reflection data and the warped observed seismic data.
